(19) United States
(12) Patent Application Publication
(10) Pub. No.: US 2013/0066537 A1
(43) Pub. Date: Mar. 14, 2013

(54) APPARATUS FOR AND METHOD OF CONTROLLING FUEL INJECTION OF INTERNAL COMBUSTION ENGINE

(71) Applicant: Masayuki SARUWATARI, Isesaki-shi (JP)

(72) Inventor: Masayuki SARUWATARI, Isesaki-shi (JP)

(73) Assignee: Hitachi Automotive Systems, Ltd.

(21) Appl. No.: 13/470,396

(22) Filed: May 14, 2012

(30) Foreign Application Priority Data
Sep. 13, 2011 (JP) 2011-200025

(51) Int. Cl. F02D 41/30; F02D 41/26

(52) U.S. Cl. 701/104

(57) ABSTRACT

A fuel injection control for an internal combustion engine is performed. A fuel injection start timing from a first fuel injection valve placed in one intake port branching off for each cylinder is set to introduce a spray of fuel into the cylinder at the timing of introducing intake air into the cylinder, and a start timing of fuel injection from a second fuel injection valve placed in the other branching intake port is set in synchronization with the completion of injection of the first fuel injection valve, to start fuel injections from the first fuel injection valve and the second fuel injection valve at these set injection start timings. Accordingly, mixing performance of a spray of fuel and air is increased, and thus, enabling improvements in drivability during deceleration (torque shock), fuel economy, and exhaust emissions.

### BACKGROUND OF THE INVENTION

1. Field of the Invention

The present invention relates to fuel injection control for an internal combustion engine equipped with two fuel injection valves in an intake passage for each cylinder to inject fuel in an intake stroke.

2. Description of Related Art

An apparatus for controlling fuel injection of an internal combustion engine disclosed in Japanese Laid-Open Patent Publication No. 2010-127261 is equipped with two fuel injection valves in an intake passage for each cylinder, in which fuel is first injected from one fuel injection valve, and after pressure in fuel piping reduced by the injection is restored, fuel is injected from the other fuel injection valve.

However, in the above-mentioned apparatus for controlling fuel injection, there is a simultaneous injection period during which fuel injections from the two fuel injection valves overlap, while both the fuel injection valves complete the injections before completion of the intake stroke to cause a no-injection period, causing a difference in the concentration level of an air-fuel mixture and hence degrading combustion quality.

### SUMMARY OF THE INVENTION

Therefore, it is an object of the present invention to improve the concentration homogeneity of an air-fuel mixture in a cylinder for fuel injection control of an internal combustion engine.

In order to achieve the above object, an aspect of the present invention provides an apparatus for controlling fuel injection of an internal combustion engine that includes:

a first fuel injection valve and a second fuel injection valve provided in an intake passage for each cylinder, to inject fuel in an intake stroke;

an operating state detector for detecting an engine operating state;

a fuel injection amount setting section for setting the respective fuel injection amounts of the first fuel injection valve and the second fuel injection valve based on the engine operating state detected by the operating state detector; and

a basic injection timing setting section for setting the injection timing of each fuel injection valve in such a manner that fuel injection is started from the first fuel injection valve in the intake stroke, and fuel injection of the second fuel injection valve is started after completion of the fuel injection of the first fuel injection valve.

An aspect of the present invention provides a method of controlling fuel injection of an internal combustion engine equipped with a first fuel injection valve and a second fuel injection valve provided in an intake passage for each cylinder, to inject fuel in an intake stroke by these fuel injection valves, the method including the steps of:

detecting an engine operating state;

setting the respective fuel injection amounts of the first fuel injection valve and the second fuel injection valve based on the detected engine operating state; and

setting the injection timing of each fuel injection valve in such a manner that fuel injection is started from the first fuel injection valve in the intake stroke, and fuel injection of the second fuel injection valve is started after completion of the fuel injection of the first fuel injection valve.

Other objects and features of aspects of the present invention will be understood from the following description with reference to the accompanying drawings.

### BRIEF DESCRIPTION OF THE DRAWINGS

FIG. 1 is a diagram illustrating a system configuration of embodiments according to the present invention;

FIG. 2 is a flowchart illustrating fuel injection control according to a first embodiment;

FIG. 3 is a time chart illustrating a fuel injection period upon fuel injection control according to the first embodiment;

FIG. 4 is a time chart illustrating a modification of the first embodiment;

FIG. 5 is a flowchart illustrating fuel injection control according to a second embodiment;

FIG. 6 is a flowchart illustrating the setting of the number of split fuel injections according to a third embodiment;

FIG. 7 is a flowchart illustrating fuel injection control according to a fourth embodiment;

FIG. 8 is a flowchart illustrating fuel injection control according to a fifth embodiment; and

FIG. 9 is a diagram illustrating another system configuration of the embodiments according to the present invention.

### DESCRIPTION OF THE PREFERRED EMBODIMENTS

Hereinafter, an embodiment of the present invention will be explained in detail with reference to the accompanying drawings.

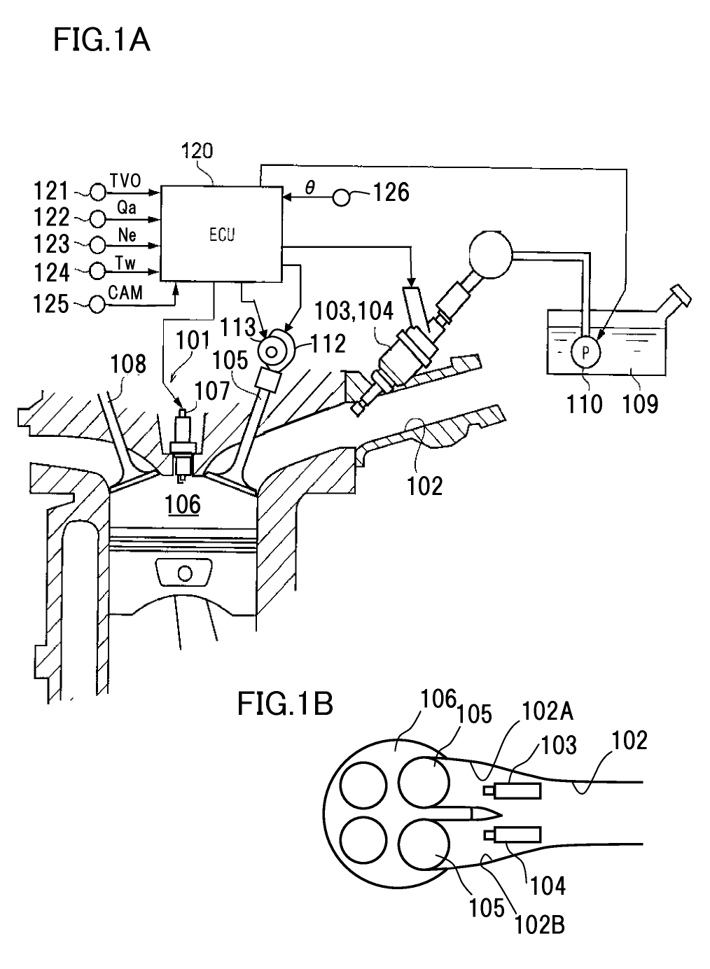

FIG. 1 is a system configuration diagram of an internal combustion engine according to the embodiments.

An internal combustion engine 101 illustrated in FIG. 1 is equipped with two intake valves 105 for each cylinder. An intake passage 102 is so formed that its downstream end branches off into two intake ports 102A and 102B leading to the respective intake valves 105.

A first fuel injection valve 103 is provided in one intake port 102A, and a second fuel injection valve 104 is provided in the other intake port 102B.

First fuel injection valve 103 and second fuel injection valve 104 are electromagnetic fuel injection valves, each of which lifts a valve body by a magnetic attractive force of an electromagnetic coil to open the valve. Since use of two injection valves can reduce the amount of injection assigned to one injection valve, an injection valve can have a small injection hole and have the advantage of atomization.

First fuel injection valve 103 and second fuel injection valve 104 inject fuel in an intake stroke in which intake valves 105 are opened, and the injected fuel and air are drawn into a combustion chamber 106. Basically, fuel injection from second fuel injection valve 104 is started after completion of injection from first fuel injection valve 103, the control of which will be described in detail later.

The air-fuel mixture in combustion chamber 106 is burned by spark ignition of a spark plug 107, and exhaust gas is discharged through an exhaust valve 108.

Fuel (gasoline) in a fuel tank 109 is pumped by a fuel pump 110 into first fuel injection valve 103 and second fuel injection valve 104, and the fuel supply pressure is controlled to a target pressure by controlling the discharge rate of fuel pump 110.

Each of the intake valves 105 is so designed that a variable valve lift mechanism 112 can continuously vary the amount of lift and the operation angle, i.e., the valve opening degree. Note that the amount of lift and the operation angle can vary at the same time in such a manner that when the characteristics of one of them are determined, the characteristics of the other will be determined.

Likewise, on the intake side, a variable valve timing mechanism 113 is provided to control a difference in rotation phase between a crankshaft and an intake side camshaft to vary continuously so as to advance or delay the valve timing (valve opening and closing timing) of each intake valve 105.

The opening and closing of exhaust valve 108 is driven by a cam axially supported by an exhaust-side camshaft while keeping the constant lift amount and the operation angle (crank angle from opening to closing). Furthermore, like on the intake side, a variable valve timing mechanism may be provided to control a difference in rotation phase between a crankshaft and an intake side camshaft to vary continuously so as to advance or delay the valve timing (valve opening and closing timing) of exhaust valve 108.

An engine control unit (ECU) 120 with a built-in microcomputer controls first fuel injection valve 103 and second fuel injection valve 104, spark plug 107, and fuel pump 109 based on detection signals from various sensors.

The various sensors include a throttle sensor 121 for measuring a not illustrated throttle valve opening degree TVO, an airflow meter 122 for measuring the intake air amount Qa of engine 101, an engine speed sensor 123 for measuring the engine speed Ne, a water temperature sensor 124 for measuring the circulating water temperature TW of engine 101, a cam sensor 125 for detecting a reference position signal (cam signal) from the intake side camshaft, i.e., the valve timing of intake valve 105, and an angle sensor 126 for measuring the rotation angle θ of a rotation mechanism in variable valve lift mechanism 112, to thereby measure the lift amount and the operation angle of intake valve 105.

In the abovementioned system, fuel injection control of first fuel injection valve 103 and second fuel injection valve 104 is performed as follows.

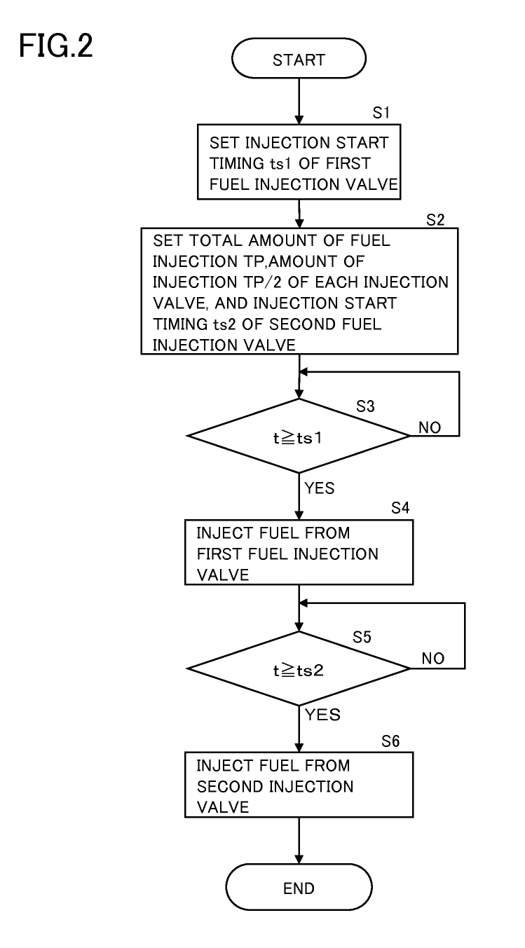

FIG. 2 is a flowchart of fuel injection control according to a first embodiment. In the first embodiment, fuel is first injected from first fuel injection valve 103, and then fuel is injected from second fuel injection valve 104.

In FIG. 2, the injection start timing ts1 of first fuel injection valve 103 is set in step S1. The injection start timing is so set that fuel injected from first fuel injection valve 103 will be introduced into combustion chamber 106 in synchronization with an intake stroke start timing calculated based on the engine operating state, for example, based on the engine load detected from the intake air amount Qa, the throttle valve opening angle TVO, and the like, and the engine speed Ne, i.e., in synchronization with the timing of introduction of air into combustion chamber 106. Specifically, the injection start timing is set earlier from the air introduction timing, by an amount of time during which a fuel spray from first fuel injection valve 103 travels until reaching intake valve 105.

In step S2, based on the engine operating state (engine load, engine speed Ne, circulating water temperature, etc.), the total amount of fuel injection TP for each cylinder and the amount of fuel injection TP/2 for each injection valve, obtained by dividing the total amount of fuel injection TP in two. Furthermore, the injection start timing ts2 of second fuel injection valve 104 is set in synchronization or approximate synchronization with the completion of injection from first fuel injection valve 103.

In step S3, it is determined whether to reach the fuel injection start timing ts1 of first fuel injection valve 103 set as mentioned above.

When it is determined to reach the fuel injection start timing ts1, fuel injection from first fuel injection valve 103 is started in step S4.

In step S5, it is determined whether to finish the fuel injection from first fuel injection valve 103 and to reach the fuel injection start timing ts2 of second fuel injection valve 104.

When it is determined to reach the fuel injection start timing ts2, fuel injection from second fuel injection valve 104 is started in step S6.

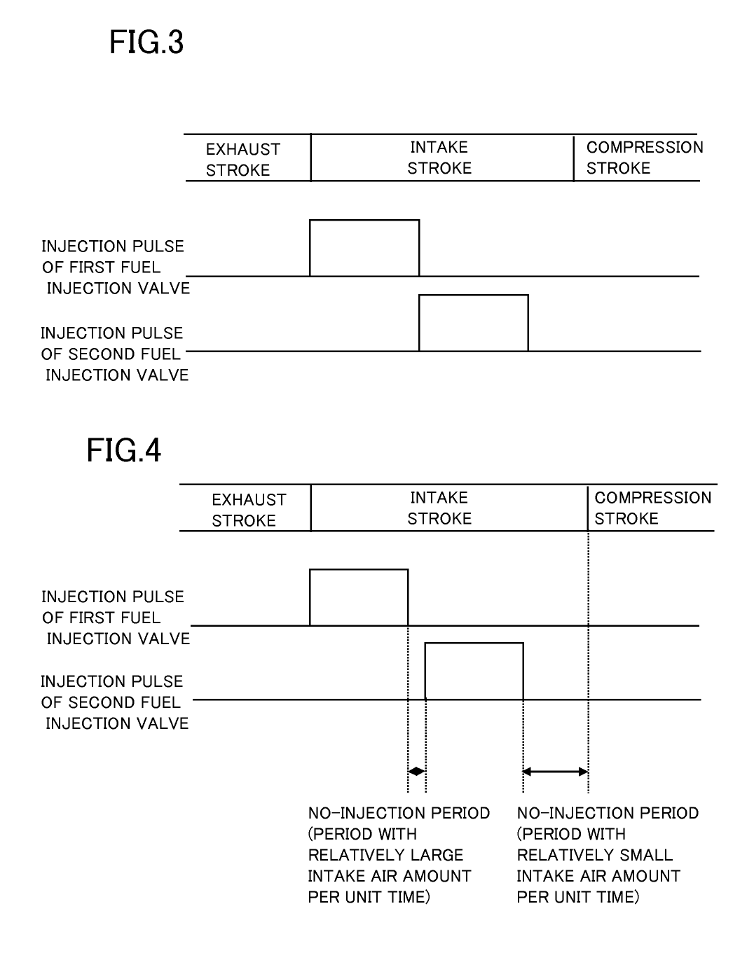

FIG. 3 is a time chart of a fuel injection period upon fuel injection control according to the first embodiment.

In this way, first fuel injection valve 103 and second fuel injection valve 104 first inject a fifty-fifty amount of fuel into different intake ports 102A and 102B, respectively, so that the diffusibility of the injected fuel into air increases, compared with a case in which the total amount of fuel is injected from one fuel injection valve into one portion, thereby improving mixing performance of fuel and air (hereinafter simply called mixing performance).

Furthermore, according to the first embodiment, since fuel injection from second fuel injection valve 104 is started after completion of fuel injection from first fuel injection valve 103 and hence the injection periods do not overlap, an uneven distribution of both the fuel components in the same space can be suppressed even after the injected fuel components from the respective injection valves meet in combustion chamber 106, further improving mixing performance.

In addition, since the injection periods of the two fuel injection valves do not overlap, the no-injection period in each intake period can be shortened as much as possible. This shortens the no-injection period of introducing only air into combustion chamber 106, further improving mixing performance.

Then, the mixing performance is improved as mentioned above while keeping highly-responsive engine performance resulting from fuel injections during the intake period, thus enabling improvements in drivability during deceleration (torque shock), fuel economy, and exhaust emissions.

FIG. 4 is a time chart illustrating a modification of the first embodiment.

In the modification, a no-injection period is divided into two periods between the completion of a first injection from first fuel injection valve 103 and the start of a second injection from second fuel injection valve 104, and between the completion of the second injection and the end of completion of the intake stroke.

According to this modification, since the no-injection period for one intake stroke is divided into two or more periods and each of the two or more periods is shortened, the mixing performance can be further improved when the no-injection period (=intake period-total injection period) is particularly long.

Note that, since in the end of the intake stroke (preferably near the bottom dead center) the intake air amount per unit period (time) is small compared with that in the middle of the intake stroke, the no-injection period may be divided only when the no-injection period (=intake period-total injection period) is equal to or greater than a predetermined value (such as a low-revolution and low-load condition). Furthermore, since the intake air amount per unit time is greater near the middle of the intake stroke than that at the end of the intake stroke, as illustrated in FIG. 4, it is preferred that the no-injection period between a first injection and a second injection in the middle of the intake stroke should be made shorter than the no-injection period at the end.

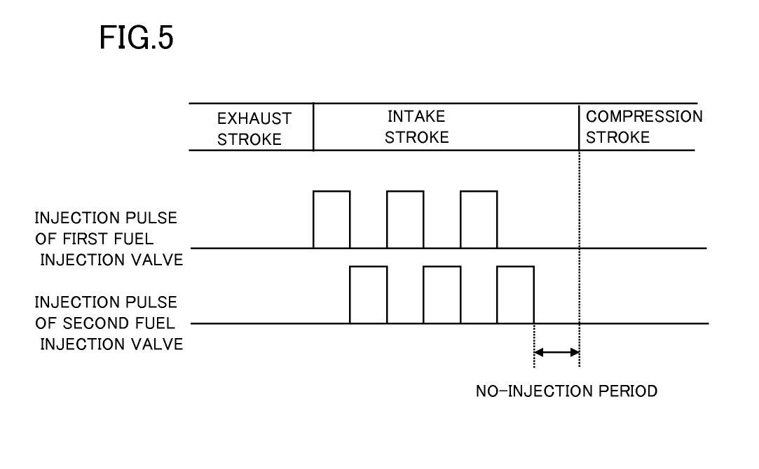

FIG. 5 is a time chart illustrating a fuel injection period upon fuel injection control according to a second embodiment.

In the second embodiment, first fuel injection valve 103 and second fuel injection valve 104 perform split injections alternately multiple times (three times in FIG. 5) on each side.

According to the second embodiment, similar to the first embodiment, since two fuel injection valves perform split fuel injections into different portions, the effect of improvement in mixing performance is obtained. In addition, since the injection periods of the respective injection valves do not overlap, one injected fuel is unlikely to overlap with the other even after introduction into combustion chamber 106 and the no-injection period can be made as short as possible, so that the effect of improvement in mixing performance can be obtained.

Furthermore, in the second embodiment, split fuel injection from each injection valve is performed at intervals, and this can prolong the period from the start of the first injection to the end of the last injection. Thus, the diffusibility of the injected fuel into air further increases compared with a case in which the amount of fuel to be injected from each injection valve is completed in one shot in a short time, enabling further improvement in mixing performance.

Therefore, the effects of improvements in drivability during deceleration (torque shock), fuel economy, and exhaust emissions resulting from the improvement in mixing performance can further increase while keeping highly-responsive engine performance resulting from the fuel injections during the intake period.

Similar to the modification of the first embodiment, the no-injection period may also be divided and interposed between respective injections in the second embodiment.

The number of split injections may be twice, four times, or more per injection valve, or the total amount of fuel injection may be divided into three injection amounts, that is, fuel is injected twice from first fuel injection valve 103 and once from second fuel injection valve 104.

Next, a third embodiment will be described. In the third embodiment, the number of split injections from each fuel injection valve is set variable according to the engine operating state.

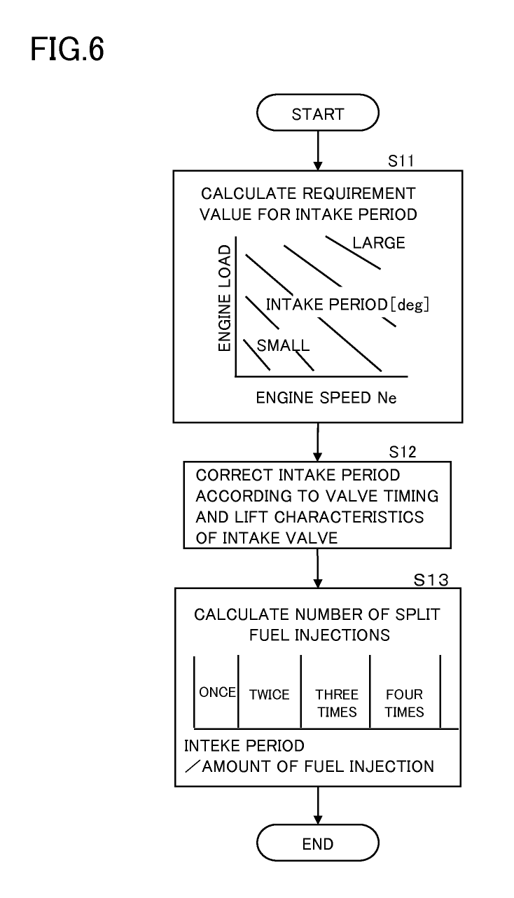

FIG. 6 is a flowchart for setting the number of split fuel injections according to the third embodiment.

In step S11, based on the engine load and the engine speed Ne, a requirement value for the intake period is calculated. Here, based on the engine load and the engine speed Ne, variable valve lift mechanism 112 sets the amount of lift and the operation angle of intake valve 105 to be variable. However, a period from the opening timing to the closing timing of intake valve 105 is not the intake period. Actually, air in the intake port is introduced by inertia into combustion chamber 106 a bit later than the opening of intake valve 105, and the introduction of air into combustion chamber 106 is virtually completed long before the closing of intake valve 105. Thus, a requirement value for the intake period from the start to the end of air introduction into combustion chamber 106 is calculated according to the engine load and the engine speed Ne.

In step S12, the requirement value for the intake period is modified. For example, when the opening timing of intake valve 105 or the rising speed of opening the valve (the angle of inclination of the lift characteristics) varies by means of variable valve timing mechanism 113 or variable valve lift mechanism 112, since the introduction timing or introduction speed of intake air into combustion chamber 106 varies to thereby change the intake period, a modified intake period is calculated. In other words, the opening timing and closing timing of intake valve 105 modified by variable valve lift mechanism 113 or variable valve timing mechanism 112 is determined to prepare for step 13 to determine the number of split injection timings for upcoming first injection pulse and second injection pulse. In variable valve lift mechanism 113 of the embodiment, the opening and closing timings also vary with a change in operation angle. Therefore, it is preferred to modify and calculate the intake period even for either a variable valve lift mechanism of this type or a variable valve timing mechanism according to the change in the opening timing of the intake valve or the rising speed of opening the valve.

In step S13, based on the intake period corrected in step S12 and the amount of fuel injection, the number of split injections per fuel injection valve is calculated. Note that “ONCE” in step S13 means that the number of injections from each fuel injection valve is once, and no split injection is performed.

As the ratio of the intake period to the amount of fuel injection (=Intake Period/Amount of Fuel Injection) increases, it becomes difficult to be mixed with air when the number of fuel injections is reduced. In other words, it is preferred to increase the number of split fuel injections to thereby increase mixing performance.

On the other hand, when Intake Period/Amount of Fuel Injection is low (when the accelerator opening is small during idling or deceleration), since the number of splits required to fulfill good mixing performance is reduced, it is requested that the number of splits should be reduced to the required number of splits to thereby reduce the load accompanied with an increase in the number of times injection valves are switched.

Therefore, as Intake Period/Amount of Fuel Injection increases (decreases), the number of split fuel injections is increased (decreased).

Thus, in the third embodiment, the number of split fuel injections is set based on the engine operating state, so that the number of splits can be limited to a required number while keeping good mixing performance in any driving state.

Therefore, in the third embodiment, the mixing performance is improved as mentioned above while keeping highly-responsive engine performance resulting from the fuel injections during the intake period, so that drivability during deceleration (torque shock), fuel economy, and exhaust emissions can be improved.

Furthermore, as mentioned above, since the number of splits is reduced to a required number for fuel injection, the following effects can be obtained.

The load on control software can be reduced, and hence the cost of a microcomputer used in a control unit can be reduced.

The reduction in the number of times of switching accompanied with the split fuel injections can lead to reduction in the amount of heat generation from the control unit, and hence reduction in the cost of a circuit radiator mechanism.

Likewise, the reduction in the number of times of switching accompanied with the split fuel injections can lead to improvement in the reliability (durability) of parts of fuel injection valves.

Next, a fourth embodiment will be described. In the fourth embodiment, the first injection from first fuel injection valve 103 and the second injection from second fuel injection valve 104 are allowed to overlap up to a predetermined proportion according to the engine operating state.

In an injection valve with a small injection hole and having the advantage of atomization, the rate of injection (the amount of injection per unit time) is low. Therefore, when the amount of fuel injection at the time of high load is shared by two injection valves, the injection period of each injection valve increases. In this case, when the intake period is shortened with high revolution, it becomes difficult to perform injections without overlapping the injection periods. When the injection periods overlap, the mixing performance is reduced. However, since two injection valves perform injections in difference spaces (intake ports), i.e., portions for introduction into the combustion chamber are different, the mixing performance is good compared with the case in which the same amount of injection is performed from one injection valve in the same portion. Furthermore, as described above, since the intake air amount per unit time is small at the end of the intake stroke, if injection is performed at the end of the intake stroke, a thick air-fuel mixture will be generated. Therefore, it is preferred that the injection be completed before the end of the intake stroke to increase the overlap period in order to obtain preferred results.

From these points, it was confirmed as a result of experiments and analysis that good mixing performance was able to be maintained if the overlap rate between the first injection and the second injection [(time period for which first fuel injection valve 103 and second fuel injection valve 104 simultaneously perform injections)/(time period for which first fuel injection valve 103 or second fuel injection valve 104 performs injection)] is set equal to or less than a predetermined value (about 50%).

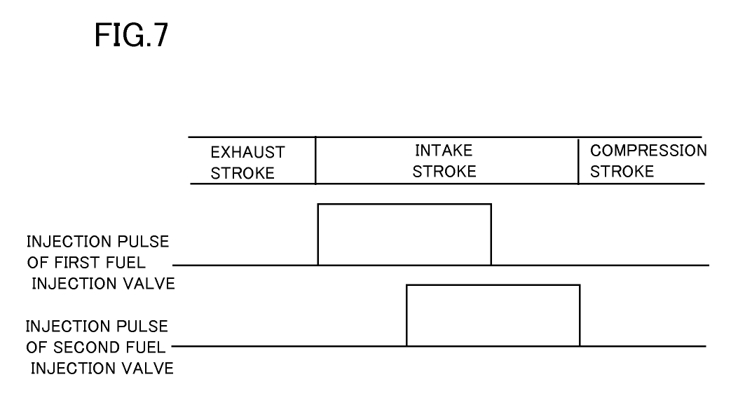

Therefore, in the embodiment, in an operating state with a short intake period and an large amount of fuel injection (with a low ratio of Intake Air Amount to Amount of Fuel Injection), injections are performed while allowing an overlap rate between the first injection and the second injection within a predetermined value (e.g., 50%) as illustrated in FIG. 7.

According to the fourth embodiment, similar to the first and second embodiments, the mixing performance is improved while keeping highly-responsive engine performance resulting from the fuel injections during the intake period, so that drivability during deceleration (torque shock), fuel economy, and exhaust emissions can be improved.

Furthermore, even in a high-revolution and high-load condition (in a high power operation), in which the ratio of Intake Air Amount to Amount of Fuel Injection becomes low, a required amount of fuel can be injected during the intake period to enable an operation with good response.

Next, a fifth embodiment will be described. This embodiment combines split injections according to the operating state in the third embodiment with the configuration for allowing overlap injections within a predetermined value in the fourth embodiment.

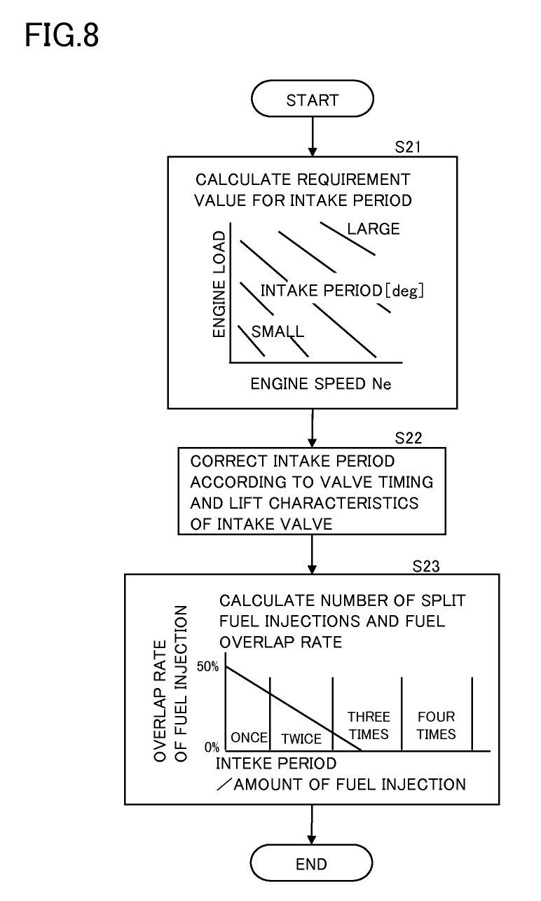

Control in the fifth embodiment will be described with reference to a flowchart of FIG. 8.

Steps S21 and S22 are the same as step S11 and S12 in FIG. 6 in the third embodiment, in which the requirement value for the intake period calculated according to the engine speed Ne and the engine load, is corrected based on the opening timing of intake valve 105 or the rising speed of opening the valve (the angle of inclination of the lift characteristics) which varies by means of variable valve timing mechanism 113 or variable valve lift mechanism 112.

In step S23, similar to step S13 of FIG. 6, the number of split fuel injections is calculated based on the ratio of the intake period to the amount of fuel injection, an overlap rate of fuel injections is calculated to decrease from a predetermined value (e.g., 50%) according to an increase in the ratio of Intake Air Amount to Amount of Fuel Injection.

According to the fifth embodiment, the mixing performance is improved while maintaining highly-responsive engine performance resulting from the fuel injections during the intake period, so that the effects of improvements in drivability during deceleration (torque shock), fuel economy, and exhaust emissions can be obtained similar to the first and second embodiments.

Particularly, as mentioned above, in an operation area with a high ratio of Intake Air Amount to Amount of Fuel Injection, in which there is no need to overlap fuel injections, the split injections can increase the mixing performance as much as possible. On the other hand, in a high-revolution and high-load condition (in a high power operation), in which the ratio of Intake Air Amount to Amount of Fuel Injection is low, an overlap rate of fuel injections is set properly so that a required amount of fuel can be injected during the intake period while maintaining good mixing performance, to enable an operation with good response.

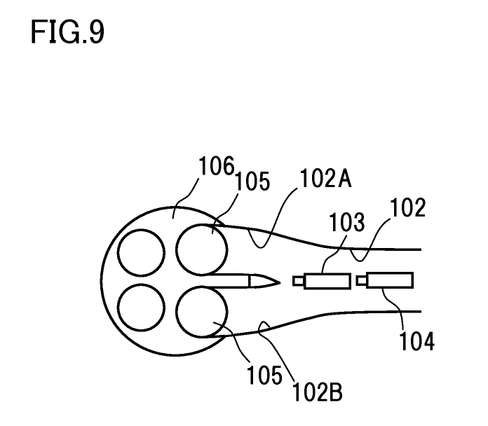

The two fuel injection valves may be so arranged that first fuel injection valve 103 is kept away on the upstream side (or downstream side) of second fuel injection valve 104 in the intake circulation direction as illustrated in FIG. 9 in addition to the arrangement in which they are placed in the respective intake ports as illustrated in FIG. 1.

The entire contents of Japanese Patent Application No. 2011-200025, filed Sep. 13, 2011, are incorporated herein by reference.

While only a select embodiment has been chosen to illustrate the present invention, it will be apparent to those skilled in the art from this disclosure that various change and modification can be made herein without departing from the scope of the invention as defined in the appended claims.

Furthermore, the foregoing description of the embodiment according to the present invention is provided for illustration only, and not for the purpose of limiting the invention; the invention is as claimed in the appended claims and their equivalents.

What is claimed is:

1. An apparatus for controlling fuel injection of an internal combustion engine, comprising:
a first fuel injection valve and a second fuel injection valve provided in an intake passage for each cylinder, to inject fuel in an intake stroke;
an operating state detector for detecting an engine operating state;
a fuel injection amount setting section for setting respective amounts of fuel injection of the first fuel injection valve and the second fuel injection valve based on the engine operating state detected by the operating state detector; and
a basic injection timing setting section for setting an injection timing of each fuel injection valve in such a manner that fuel injection is started from the first fuel injection valve in the intake stroke, and fuel injection of the second fuel injection valve is started after completion of the fuel injection of the first fuel injection valve.

2. The apparatus for controlling fuel injection of an internal combustion engine according to claim 1, wherein
the basic injection timing setting section sets an injection timing of each fuel injection valve in such a manner to make the first fuel injection valve and the second fuel injection valve perform injections alternately with the fuel injection of at least one fuel injection valve split into a plurality of fuel injections.

3. The apparatus for controlling fuel injection of an internal combustion engine according to claim 2, wherein
the basic injection timing setting section sets an injection timing of each fuel injection valve to set the number of split injections of each fuel injection valve in the split injection system to be variable according to the engine operating state.

4. The apparatus for controlling fuel injection of an internal combustion engine according to claim 1, further comprising
a first corrected injection timing setting section for setting an injection timing of the second fuel injection valve to start the injection of the second fuel injection valve before completion of the injection of the first fuel injection valve, according to the engine operating state.

5. The apparatus for controlling fuel injection of an internal combustion engine according to claim 4, wherein
the first corrected injection timing setting section sets an overlap rate between a first injection from the first fuel injection valve and a second injection from the second fuel injection valve, which is obtained by [(time period for which the first fuel injection valve and the second fuel injection valve perform injections simultaneously)/(time period for which the first fuel injection valve or the second fuel injection valve performs injection)], to a rate which is equal to or less than 50%.

6. The apparatus for controlling fuel injection of an internal combustion engine according to claim 1, further comprising
a second corrected injection timing setting section for calculating, based on the engine operating state, an intake period during which fuel injected from the first fuel injection valve and the second fuel injection valve is able to reach an inside of the cylinder and setting fuel injection timings of the first fuel injection valve and the second fuel injection valve according to the calculated intake period.

7. The apparatus for controlling fuel injection of an internal combustion engine according to claim 6, wherein
the internal combustion engine is equipped with a variable valve mechanism capable of making lift characteristics of an intake valve be variable, and
the second corrected injection timing setting section calculates the intake period according to an opening timing of the intake valve varying by means of the variable valve mechanism or a rising speed of opening the valve (an angle of inclination of the lift characteristics).

8. The apparatus for controlling fuel injection of an internal combustion engine according to claim 6, wherein
the second corrected injection timing setting section sets an injection timing of each fuel injection valve to make the first fuel injection valve and the second fuel injection valve perform injections alternately with the fuel injection of at least one fuel injection valve split into a plurality of fuel injections, and calculates the number of split injections per fuel injection valve in the split fuel injection system based on the calculated intake period and an amount of fuel injection.

9. The apparatus for controlling fuel injection of an internal combustion engine according to claim 8, wherein
the second corrected injection timing setting section sets an increasing number of split fuel injections as the intake period and the amount of fuel injection increases.

10. The apparatus for controlling fuel injection of an internal combustion engine according to claim 8, wherein
the second corrected injection timing setting section calculates an overlap rate between a first injection from the first fuel injection valve and a second injection from the second fuel injection valve, which is obtained by [(time period for which the first fuel injection valve and the second fuel injection valve perform injections simultaneously)/(time period for which the first fuel injection valve or the second fuel injection valve performs injection)], to decrease from a predetermined value as a ratio of an intake air amount to an amount of fuel injection increases.

11. An apparatus for controlling fuel injection of an internal combustion engine, comprising:
a first fuel injection valve and a second fuel injection valve provided in an intake passage for each cylinder, to inject fuel in an intake stroke;
operating state detecting means for detecting an engine operating state;
fuel injection amount setting means for setting respective amounts of fuel injection of the first fuel injection valve and the second fuel injection valve based on the detected engine operating state; and
basic injection timing setting means for setting an injection timing of each fuel injection valve in such a manner that fuel injection is started from the first fuel injection valve in the intake stroke, and fuel injection of the second fuel injection valve is started after completion of the fuel injection of the first fuel injection valve.

12. A method of controlling fuel injection of an internal combustion engine equipped with a first fuel injection valve and a second fuel injection valve provided in an intake passage for each cylinder, to inject fuel in an intake stroke by means of these fuel injection valves, the method comprising the steps of:
detecting an engine operating state;
setting respective amounts of fuel injection of the first fuel injection valve and the second fuel injection valve based on the detected engine operating state; and
setting an injection timing of each fuel injection valve in such a manner that fuel injection is started from the first fuel injection valve in the intake stroke, and fuel injection of the second fuel injection valve is started after completion of the fuel injection of the first fuel injection valve.

13. The method of controlling fuel injection of an internal combustion engine according to claim 12, wherein
the step of setting the injection timing of each fuel injection valve includes the step of
setting an injection timing of each fuel injection valve in such a manner to make the first fuel injection valve and the second fuel injection valve perform injections alternately with the fuel injection of at least one fuel injection valve split into a plurality of fuel injections.

14. The method of controlling fuel injection of an internal combustion engine according to claim 13, wherein
the step of setting an injection timing of each fuel injection valve includes the step of setting the number of split injections of each fuel injection valve in the split injection system to be variable according to the engine operating state.

15. The method of controlling fuel injection of an internal combustion engine according to claim 12, further comprising the step of
starting the injection of the second fuel injection valve before completion of the injection of the first fuel injection valve according to the engine operating state.

16. The method of controlling fuel injection of an internal combustion engine according to claim 15, wherein
the step of starting the injection of the second fuel injection valve before completion of the injection of the first fuel injection valve includes the step of
setting an overlap rate between a first injection from the first fuel injection valve and a second injection from the second fuel injection valve, which is obtained by [(time at which the first fuel injection valve and the second fuel injection valve perform injections simultaneously)/(time at which the first fuel injection valve or the second fuel injection valve performs injection)] to a rate equal to or less than 50%.

17. The method of controlling fuel injection of an internal combustion engine according to claim 12, further comprising the step of
calculating, based on the engine operating state, an intake period during which fuel injected from the first fuel injection valve and the second fuel injection valve is able to reach an inside of the cylinder, and setting fuel injection timings of the first fuel injection valve and the second fuel injection valve according to the calculated intake period.

18. The method of controlling fuel injection of an internal combustion engine according to claim 17, wherein
the internal combustion engine is equipped with a variable valve mechanism capable of making lift characteristics of an intake valve variable, and
in the step of setting the fuel injection timings of the first fuel injection valve and the second fuel injection valve according to the calculated intake period, the intake period is calculated according to an opening timing of the intake valve varying by means of the variable valve mechanism or a rising speed of opening the valve (an angle of inclination of the lift characteristics).

19. The method of controlling fuel injection of an internal combustion engine according to claim 17, wherein
in the step of setting the fuel injection timings of the first fuel injection valve and the second fuel injection valve according to the calculated intake period, an injection timing of each fuel injection valve is set to make the first fuel injection valve and the second fuel injection valve perform injections alternately with the fuel injection of at least one fuel injection valve split into a plurality of fuel injections, and the number of split injections per fuel injection valve in the split fuel injection system is calculated based on the calculated intake period and an amount of fuel injection.

20. The method of controlling fuel injection of an internal combustion engine according to claim 19, wherein
in the step of setting the fuel injection timings of the first fuel injection valve and the second fuel injection valve according to the calculated intake period, an overlap rate between a first injection from the first fuel injection valve and a second injection from the second fuel injection valve, which is obtained by [(time period for which the first fuel injection valve and the second fuel injection valve perform injections simultaneously)/(time period for which the first fuel injection valve or the second fuel injection valve performs injection)] is calculated to decrease from a predetermined value as a ratio of an intake air amount to an amount of fuel injection increases.
